(19) United States
(12) Patent Application Publication
(10) Pub. No.: US 2026/0062594 A1
(43) Pub. Date: Mar. 5, 2026

(54) ADHESIVE PROTECTIVE FILM, OPTICAL MEMBER COMPRISING THE SAME, AND OPTICAL DISPLAY APPARATUS COMPRISING THE SAME

(71) Applicant: SAMSUNG SDI CO., LTD., Yongin-si (KR)

(72) Inventors: Geon Yong MAENG, Suwon-si (KR); Dong Myeong SHIN, Suwon-si (KR); Kyoung Gon PARK, Suwon-si (KR); Do Young KIM, Suwon-si (KR); Jin Young LEE, Suwon-si (KR); Sung Hyun MUN, Suwon-si (KR); Sung Han KIM, Suwon-si (KR); Ji Won KANG, Suwon-si (KR); Il Jin KIM, Suwon-si (KR)

(21) Appl. No.: 19/313,273

(22) Filed: Aug. 28, 2025

(30) Foreign Application Priority Data
Aug. 28, 2024 (KR) 10-2024-0116102

(51) Int. Cl. C09J 7/38; B32B 7/12; B32B 27/08; B32B 27/28; B32B 27/30; C09J 4/06; C09J 5/02

(52) U.S. Cl. CPC C09J 7/385; B32B 7/12; B32B 27/08; B32B 27/281; B32B 27/308; C09J 4/06; C09J 5/02; B32B 2551/00; C09J 2203/326; C09J 2301/414; C09J 2479/088

(57) ABSTRACT

An adhesive protective film for polyimide-based optical devices containing polyimide ash, an optical member, and an optical display apparatus including the same are disclosed. The adhesive protective film includes a cured product of a composition comprising: a (meth)acrylic copolymer; a curing agent; a (meth)acrylic oligomer; and an aromatic group-containing mono- or higher functional (meth)acrylic monomer, wherein the adhesive protective film has a storage modulus of 0.1 MPa or less at −20° C., a peel strength of 350 gf/inch or more at 60° C. and 93% RH (relative humidity) with respect to a polyimide-based optical device containing a polyimide ash, and a creep of 40% or less at 60° C.

### CROSS-REFERENCE TO RELATED APPLICATION

The present application claims priority to and the benefit of Korean Patent Application No. 10-2024-0116102, filed on Aug. 28, 2024, in the Korean Intellectual Property Office, the entire disclosure of which is incorporated herein by reference.

### BACKGROUND

### 1. Field

The present disclosure relates to an adhesive protective film, an optical member, and an optical display apparatus.

### 2. Description of the Related Art

In a related art device, such as an optical member or an electronic member, a protective film composed of an adhesive layer alone or a protective film composed of a base film and an adhesive layer is attached to a surface of the device to prevent scratches from forming thereon during processes, such as processing, assembly, inspection, and/or the like. Such a protective film is used by removing a release film from the adhesive layer. In recent years, as optical members, organic light emitting diode (OLED) devices have been replacing liquid crystal devices. In addition, flexible OLED devices are more increasingly used in the related art.

Unlike liquid crystal devices or typical OLED devices, flexible OLED devices are highly flexible and thus require a process protective film to protect an OLED panel from surface scratches during processing, assembly, inspection, and/or the like. The process protective film requires low peel strength and reworkability so as to be (e.g., easily) removed if defects, such as cosmetic abnormalities or foreign matter, are detected (or generated) during panel inspection. After the panel inspection, a P-film (patterned film) is permanently attached to the panel to support the panel while protecting the panel from moisture and/or an external environment. Because the P-film must be permanently attached to the panel, the P-film is required to have high peel strength and reliability.

Accordingly, because a related art panel manufacturing process requires a low peel strength process protective film, which is used temporarily, and a high peel strength P-film, which has high peel strength, there is a need for processes of process protective film attachment→process protective film removal→P-film attachment.

In recent years, cost reduction and process optimization have been ongoing. In particular, if (e.g., when) used as a process protective film before UV irradiation, the process protective film is patterned by a laser. Here, if (e.g., when) initial peel strength of the protective film with respect to a polyimide substrate is higher than a certain degree (e.g., certain value), there can be a problem of deterioration in yield due to decrease in peeling success rate. Therefore, it may be desirable to provide a protective adhesive film that has low peel strength if (e.g., when) stacked on the polyimide substrate and exhibits high peel strength after UV irradiation in order to incorporate the process protective film into the P-film.

The background technique of the present disclosure is disclosed in Japanese Patent Registration No. 5,683,369 and/or the like.

### SUMMARY

An aspect according to embodiments of the present disclosure is directed toward an adhesive protective film that exhibits high adhesion with respect to a polyimide-based optical device containing polyimide ash under high temperature/humidity conditions.

An aspect according to embodiments of the present disclosure is directed toward an adhesive protective film that exhibits good foldability.

An aspect according to embodiments of the present disclosure is directed toward an adhesive protective film that exhibits good wettability with respect to a polyimide-based optical device containing polyimide ash.

One aspect of the present disclosure relates to an adhesive protective film for polyimide-based optical devices containing polyimide ash.

The adhesive protective film includes a cured product of a composition including a (meth)acrylic copolymer, a curing agent, a (meth)acrylic oligomer, and an aromatic group-containing mono- or higher functional (meth)acrylic monomer, wherein the adhesive protective film has a storage modulus of 0.1 MPa or less at −20° C., a peel strength of 350 gf/inch or more at 60° C. and 93% relative humidity (RH) with respect to a polyimide-based optical device containing a polyimide ash, and a creep of 40% or less at 60° C.

Another aspect of the present disclosure relates to an optical member.

The optical member includes: a polyimide-based optical device having at least one surface containing a polyimide ash thereon and an adhesive layer bonded to the at least one surface (i.e., the polyimide ash-containing surface), wherein the adhesive layer includes the adhesive protective film.

A further aspect of the present disclosure relates to an optical display apparatus.

The optical display apparatus includes a cured product of the adhesive protective film or the optical member.

Embodiments of the present disclosure provide an adhesive protective film that exhibits high peel strength with respect to a polyimide-based optical device containing polyimide ash under high temperature/humidity conditions.

Embodiments of the present disclosure provide an adhesive protective film that exhibits good foldability.

Embodiments of the present disclosure provide an adhesive protective film that exhibits good wettability with respect to a polyimide-based optical device containing polyimide ash.

### BRIEF DESCRIPTION OF THE DRAWINGS

The above and other objects, features and enhancements of the present disclosure will become more apparent to those of ordinary skill in the art by describing example embodiments thereof in more detail with reference to the accompanying drawings, in which:

FIG. 1 is a schematic illustration of a method of forming a polyimide layer containing polyimide ash according to one or more embodiments of the present disclosure.

FIG. 2 is a schematic illustration of a method of forming a polyimide layer containing polyimide ash according to one or more embodiments of the present disclosure.

FIG. 3 is a schematic diagram illustrating a laser irradiation process during formation of a polyimide layer containing polyimide ash.

FIG. 4 is a cross-sectional view of an optical member according to one or more embodiments.

FIG. 5 is a diagram illustrating an evaluation method of a simulated bubble fraction.

FIG. 6 shows an evaluation result of the simulated bubble fraction.

### DETAILED DESCRIPTION

Hereinafter, example embodiments of the present disclosure will be described in more detail with reference to the accompanying drawings such that the present disclosure can be (e.g., easily) implemented by a person having ordinary knowledge in the art. It should be understood that the present disclosure may be embodied in various ways and is not limited to the following embodiments.

The terminology used herein is for the purpose of describing example embodiments and is not intended to limit the present disclosure. As used herein, the singular forms “a”, “an”, and “the” are intended to include the plural forms as well, unless the context specifically indicates otherwise.

Herein, the term “(meth)acryl” refers to acryl and/or methacryl.

Herein, the term “copolymer” may include a polymer or a resin.

Herein, the term “glass transition temperature” may refer to a glass transition temperature (Tg) measured on a target monomer or polymer using a differential scanning calorimeter (DSC, e.g., DSC Discovery from TA Instruments). For example, a homopolymer of the target monomer is heated to 180° C. at a heating rate of 20° C./min, slowly cooled to −100° C., and then heated again (e.g., in a second heating process) to 100° C. at a heating rate of 10° C./min to obtain data of an endothermic transition curve. An inflection point of the endothermic transition curve (e.g., obtained from the second heating process) may be defined as the glass transition temperature of the target monomer.

As used herein to represent a specific numerical range, “X to Y” means a value greater than or equal to X and less than or equal to Y (X≤ and ≤Y).

According to one or more embodiments, an adhesive protective film has a peel strength of 350 gf/inch or more at 60° C. and 93% RH (relative humidity) with respect to a polyimide-based optical device containing a polyimide ash, a storage modulus of 0.1 MPa or less at −20° C., and a creep of 40% or less at 60° C.

The “polyimide-based optical device” refers to a polymer film processed (e.g., produced) by polymerization of a polyamic acid precursor that contains imide and aromatic groups in repeat units, has excellent mechanical and heat resistance properties, and can be used as a substrate for a flexible OLED panel.

In one or more embodiments, the polyimide-based optical device may be provided in the form of a polyimide layer.

First, a method of forming a polyimide layer including a polyimide ash-containing surface will be described in more detail.

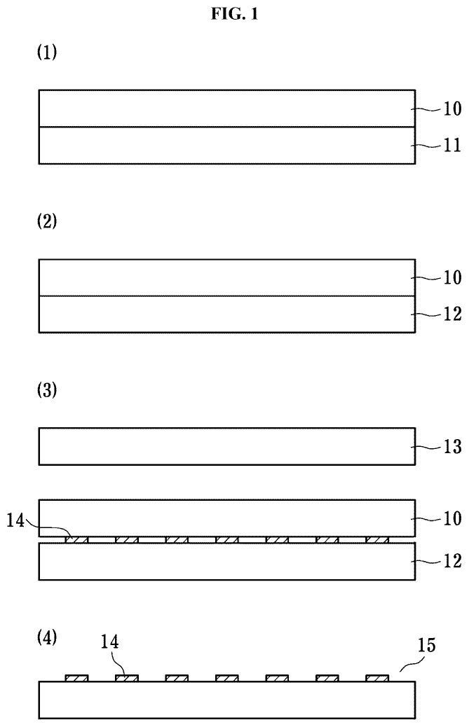

FIG. 1 is a schematic illustration of a method of forming a polyimide layer containing polyimide ash according to one or more embodiments.

Referring to FIG. 1, in (1), a polyimide varnish is deposited to a set or predetermined thickness on a lower surface of a glass plate 10 to form a polyimide varnish coat 11.

In (2), the polyimide varnish coat 11 is dried and cured to form a polyimide layer 12 on the lower surface of the glass plate 10.

In (3), the glass plate 10 is irradiated with a laser beam emitted from a laser irradiator 13 placed above the glass plate 10, and polyimide ash (e.g., residues, or particles) 14 is formed on an upper surface of the polyimide layer 12.

Laser irradiation may form the polyimide ash 14 by burning a portion of the polyimide layer 12. The polyimide ash may refer to fine (e.g., small) irregularities in the form of dust (e.g., residues, or particles), which may form a fine (e.g., small) step between a laser-treated portion and a non-laser treated portion. The step can facilitate delamination of the glass plate in step (4) below. The extent to which the polyimide ash 14 is formed and/or the area ratio of the polyimide ash 14 (ratio of the total area of the polyimide ash to the total area of the polyimide layer) may be adjusted depending on the type or kind of polyimide varnish, the total thickness of the polyimide layer, the degree of irradiation with laser beams, and/or the like.

In (4), the glass plate 10 may be removed from the polyimide layer 12, thereby providing a polyimide layer 15 that includes a surface containing the polyimide ash 14.

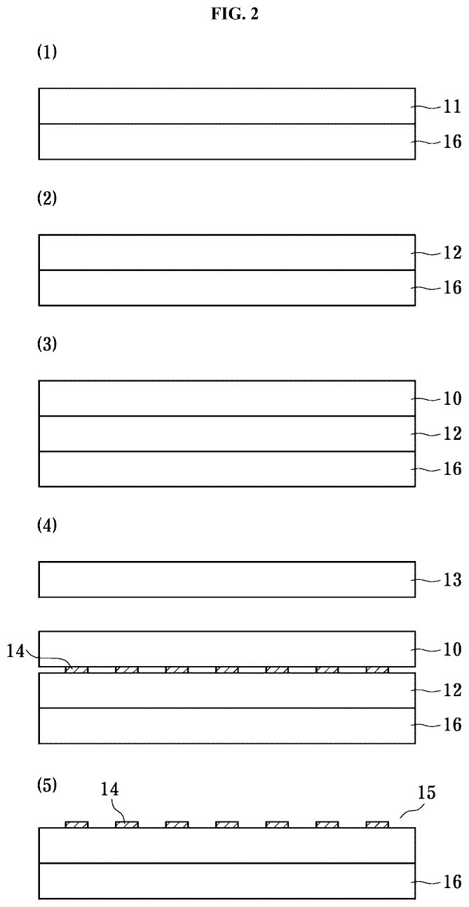

FIG. 2 is a schematic illustration of a method of forming a polyimide layer containing polyimide ash according to one or more embodiments.

Referring to FIG. 2, in (1), a polyimide varnish is deposited to a set or predetermined thickness on an upper surface of a release base film 16 to form a polyimide varnish coat 11.

In (2), the polyimide varnish coat 11 is dried and cured to form a polyimide layer 12 on the upper surface of the release base film 16.

In (3), a glass plate 10 is disposed on an upper surface of the polyimide layer 12.

In (4), the glass plate 10 is irradiated with a laser beam emitted from a laser irradiator 13 placed above the glass plate, and polyimide ash (e.g., residues, or particles) 14 is formed on the upper surface of the polyimide layer 12. Laser treatment may form the polyimide ash by burning a portion of the polyimide layer 12. The polyimide ash may refer to fine (e.g., small) irregularities in the form of dust (e.g., residues, or particles), which may form a fine (e.g., small) step between a laser-treated portion and a non-laser treated portion. The step can facilitate delamination of the glass plate in step (5) below. The extent to which the polyimide ash 14 is formed and/or the area ratio of the polyimide ash 14 (ratio of the total area of the polyimide ash to the total area of the polyimide layer) may be adjusted depending on the type or kind of polyimide varnish, the total thickness of the polyimide layer, the degree of irradiation with laser beams, and/or the like.

In (5), the glass plate 10 may be removed from the polyimide layer 12, thereby providing a laminate of a polyimide layer 15 having the polyimide ash 14 on a surface thereof and the release base film 16.

The release base film 16 is subjected to release treatment with silicone and/or the like and thus can be (e.g., easily) removed.

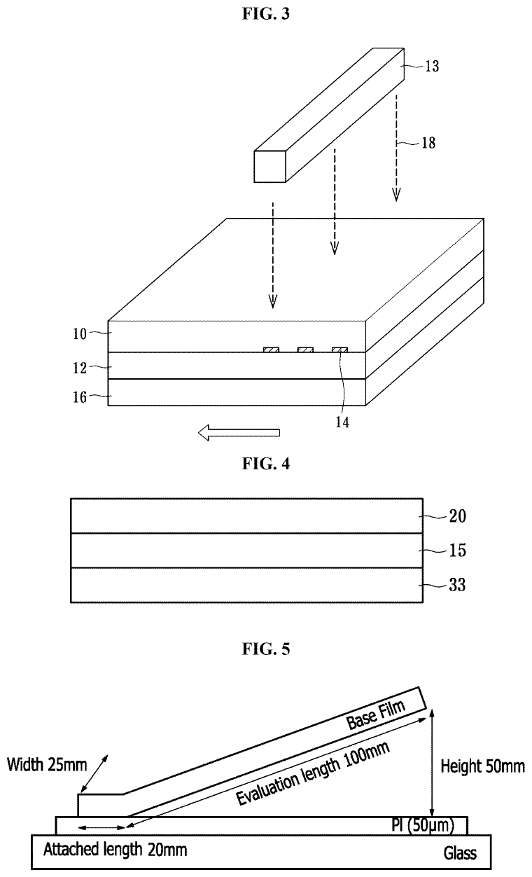

FIG. 3 is a schematic diagram illustrating a laser irradiation process during formation of a polyimide layer containing polyimide ash (e.g., residues, or particles).

Referring to FIG. 3, a laminate in which a polyimide layer 12 and a glass plate 10 are sequentially stacked on an upper surface of a release base film 16 is prepared, and polyimide ash 14 is formed on an upper surface of the polyimide layer 12 by irradiating the laminate with laser beams 18 using a laser irradiation device 13 from above an upper surface of the glass plate 10. The laminate is conveyed in a certain direction (arrow direction, e.g., right to left) and the polyimide ash 14 may be discontinuously formed on the upper surface of the polyimide layer 12 by adjusting on-off of laser irradiation.

The glass plate is an alkali-free glass plate and may have a thickness of 1 mm to 2 mm.

The polyimide varnish may include 90 wt % or more of at least one selected from among a polyimide copolymer, a polyimide oligomer, and a polyimide monomer, without being limited thereto. For example, the polyimide varnish may include SD Flex (DuPont), without being limited thereto.

The polyimide varnish may be deposited by any suitable method (e.g., typical method known to those skilled in the art). For example, the polyimide varnish may be deposited by a doctor blade coating method. In this method, the gauge may have a diameter of 0.5 mm to 1.0 mm, for example, 0.65 mm. The polyimide varnish may be deposited to a thickness of 20 μm to 30 μm.

The polyimide varnish coat may be dried and cured to form a polyimide layer.

Drying may include heat treatment at 50° C. to 200° C. for 5 min to 60 min. For drying, heat treatment may be performed once or more, for example, twice or more. In one or more embodiments, heat treatment may be performed twice or more. For example, drying may include a primary heat treatment at 50° C. to 100° C. for 5 min to 30 min and a secondary heat treatment at 100° C. to 200° C. for 5 min 30 min. For example, the primary heat treatment is performed at 80° C. for 10 min and the secondary heat treatment is performed at 120° C. for 20 min.

A dried product of the polyimide varnish coat may have a thickness of 20 μm to 30 μm, for example, 20 μm.

Curing may include heat treatment at a higher temperature for a longer period of time than drying. Such heat treatment can form a polyimide layer through imidization of the dried product of the polyimide varnish coat. Heat treatment may include heat treatment at a temperature of greater than 200° C. and less than or equal to 400° C. for 30 min to 120 min. In one or more embodiments, heat treatment may be performed once or more. For example, curing includes heat treatment at 250° C. for 60 min.

The polyimide layer may have a thickness of 20 μm to 30 μm, for example, 20 μm.

Laser irradiation may include irradiation at a dose of 100 mJ/cm² to 500 mJ/cm², for example, 150 mJ/cm² to 200 mJ/cm². Within these ranges, a polyimide ash capable of being (e.g., easily) peeled off of the glass plate can be formed. Laser irradiation may include light irradiation at a wavelength of 308 nm and may include picosecond, nanosecond, or femtosecond of irradiation.

The adhesive protective film has a peel strength of 350 gf/inch or more at 60° C. and 93% RH with respect to a polyimide-based optical device containing polyimide ash, thereby facilitating provision of good foldability if (e.g., when) attached to a polyimide-based optical device containing polyimide ash. For example, the adhesive protective film may have a peel strength of 350 gf/inch to 600 gf/inch at 60° C. and 93% RH.

The adhesive protective film has a storage modulus of 0.1 MPa or less at −20° C. Within this range, the adhesive protective film can facilitate provision of good foldability if (e.g., when) attached to a polyimide-based optical device containing polyimide ash. For example, the adhesive protective film may have a storage modulus of 0.03 MPa to 0.1 MPa at −20° C.

The adhesive protective film has a creep of 40% or less at 60° C. Within this range, the adhesive protective film can facilitate provision of good foldability if (e.g., when) attached to a polyimide-based optical device containing polyimide ash. For example, the adhesive protective film may have a creep of 15% to 40% at 60° C.

The adhesive protective film has a simulated bubble fraction of 3.5% or less. Within this range, the adhesive protective film can facilitate provision of good foldability if (e.g., when) attached to a polyimide-based optical device containing polyimide ash.

To achieve the above peel strength, modulus, creep, and simulated bubble fraction, the adhesive protective film includes a cured product of a composition including a (meth)acrylic copolymer, a curing agent, a (meth)acrylic oligomer, and an aromatic group-containing mono- or higher functional (meth)acrylic monomer.

In one or more embodiments, the adhesive protective film may include a (meth)acrylic copolymer, a curing agent, a (meth)acrylic oligomer, and an aromatic group-containing mono- or higher functional (meth)acrylic monomer. These components may be derived from the composition. In one or more embodiments, the adhesive protective film may include a (meth)acrylic copolymer, and one or more selected from among a curing agent, a (meth)acrylic oligomer, and an aromatic group-containing mono- or higher functional (meth)acrylic monomer. These components may be derived from the composition.

In one or more embodiments, the curing agent may be a thermally cured product. For example, the curing agent may be a heat curing agent suitable for thermal curing.

Hereinafter, each component of the composition will be described in more detail.

### (Meth)Acrylic Copolymer

The (meth)acrylic copolymer serves to form a matrix of the adhesive protective film and can be cured by an isocyanate curing agent to secure peel strength of the adhesive protective film.

The (meth)acrylic copolymer may have a glass transition temperature (Tg) of −10° C. or less, for example, −80° C. to −20° C. Within these ranges, the (meth)acrylic copolymer can help provide suitable wettability (adhesion) to the polyimide-based optical device and suitable initial peel strength of the adhesive protective film.

The (meth)acrylic copolymer may be a copolymer of a monomer mixture including a (meth)acrylic monomer having a homopolymer glass transition temperature of 60° C. or less and a (meth)acrylic monomer having a crosslinking functional group such as a hydroxyl group-containing (meth)acrylic monomer.

In one or more embodiments, the (meth)acrylic monomer having a homopolymer glass transition temperature of 60° C. or less and the (meth)acrylic monomer having a crosslinking functional group may be present in a total amount of 95 wt % or more, for example, 99 wt % to 100 wt %, or, 100 wt %, in the monomer mixture.

For example, the (meth)acrylic monomer having a homopolymer glass transition temperature of 60° C. or less may have a homopolymer glass transition temperature of −80° C. to 60° C. Within this range, the adhesive protective film can (e.g., easily) realize the effects thereof.

The (meth)acrylic monomer having a homopolymer glass transition temperature of 60° C. or less may be present in an amount of 80 wt % or more, for example, 80 wt % to 99 wt %, 80 wt % to 95 wt %, or, 85 wt % to 99 wt %.

The (meth)acrylic monomer having a homopolymer glass transition temperature of 60° C. or less may be a mixture of two or more (meth)acrylic monomers having different homopolymer glass transition temperatures.

In one or more embodiments, the (meth)acrylic monomer having a homopolymer glass transition temperature of 60° C. or less may be a mixture of a 1 (meth)acrylic monomer having a homopolymer glass transition temperature of −80° C. to −20° C., for example, −70° C. to −55° C. (referred to as a first monomer for convenience of description) and a (meth)acrylic monomer having a homopolymer glass transition temperature of −80° C. to −20° C., for example, −60° C. to −40° C. (referred to as a second monomer for convenience of description).

In one or more embodiments, the (meth)acrylic monomer having a homopolymer glass transition temperature of 60° C. or less may be a mixture of a (meth)acrylic acid ester having a straight C₁ to C₂₀ alkyl group and a (meth)acrylic acid ester having a branched C₁ to C₂₀ alkyl group.

In one or more embodiments, each of the (meth)acrylic acid ester having a straight C₁ to C₂₀ alkyl group and a (meth)acrylic acid ester having a branched C₁ to C₂₀ alkyl group may be selected from among (meth)acrylic acid esters having C₁ to C₂₀ alkyl groups listed below. For example, the (meth)acrylic acid ester having a straight C₁ to C₂₀ alkyl group may include n-propyl (meth)acrylate, n-butyl (meth)acrylate, and/or the like. The (meth)acrylic acid ester having a branched C₁ to C₂₀ alkyl group may include 2-ethylhexyl (meth)acrylate and/or the like.

In one or more embodiments, the (meth)acrylic acid ester having a straight C₁ to C₂₀ alkyl group may be present in an amount of 5 wt % to 50 wt %, for example, 5 wt % to 45 wt %, or, 10 wt % to 40 wt %, in the monomer mixture. The (meth)acrylic acid ester having a branched C₁ to C₂₀ alkyl group may be present in an amount of 50 wt % to 90 wt %, for example, 50 wt % to 80 wt %, in the monomer mixture. Within these ranges, the adhesive protective film can (e.g., easily) realize the effects thereof.

The hydroxyl group-containing (meth)acrylic monomer may be a (meth)acrylate containing at least one hydroxyl group. For example, the hydroxyl group-containing (meth)acrylate may include at least one selected from among 2-hydroxyethyl (meth)acrylate, 3-hydroxypropyl (meth)acrylate, 4-hydroxybutyl (meth)acrylate, hydroxyhexyl (meth)acrylate, 1,4-cyclohexanedimethanol mono(meth)acrylate, 1-chloro-2-hydroxypropyl (meth)acrylate, diethylene glycol 1 mono(meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexanedimethanol mono(meth)acrylate.

The hydroxyl group-containing (meth)acrylic monomer may be present in an amount of 0.1 wt % to 20 wt %, for example, 1 wt % to 20 wt %, 5 wt % to 20 wt %, or, 0.5 wt % to 15 wt %, in the monomer mixture. Within these ranges, the hydroxyl group-containing (meth)acrylic monomer can effectively impart cohesion to an adhesive layer to form the adhesive layer and can effectively provide initial peel strength to the adhesive protective film.

In one or more embodiments, the monomer mixture may be free from an aromatic group-containing monomer. It can be difficult for an adhesive protective film prepared from a (meth)acrylic copolymer formed of the aromatic group-containing monomer to realize the effects of the adhesive protective film according to the present disclosure.

In one or more embodiments, the (meth)acrylic monomer having a homopolymer glass transition temperature of 60° C. or less and the hydroxyl group-containing (meth)acrylic monomer may be present in a total amount of 99 wt % or more, for example, 99 wt % to 100 wt %, or, 100 wt %, in the monomer mixture.

The (meth)acrylic copolymer may be prepared by polymerizing the monomer mixture by a suitable (e.g., typical) polymerization method. The polymerization method may include any suitable method (e.g., typical method known to those skilled in the art). For example, the (meth)acrylic copolymer may be prepared by adding an initiator to the monomer mixture, followed by suitable (e.g., typical) copolymerization, for example, suspension polymerization, emulsion polymerization, solution polymerization, and/or the like. Polymerization may be performed at a temperature of 60° C. to 70° C. for 4 hours to 8 hours. The initiator may be selected from suitable (e.g., typical) initiators including an azo-based polymerization initiator and/or peroxides, such as benzoyl peroxide or acetyl peroxide.

### (Meth)Acrylic Oligomer

The (meth)acrylic oligomer has a glass transition temperature of 60° C. or less and a weight average molecular weight of 100,000 g/mol or less. Within this range of glass transition temperature and weight average molecular weight, the (meth)acrylic oligomer can provide good foldability at room temperature and under high temperature/humidity conditions.

For example, the (meth)acrylic oligomer may have a glass transition temperature of −10° C. to 60° C., for example, 0° C. to 30° C. For example, the (meth)acrylic oligomer may have a weight average molecular weight of 10,000 g/mol to 100,000 g/mol, for example, 20,000 g/mol to 50,000 g/mol.

The (meth)acrylic oligomer may be prepared from suitable monomers (e.g., some monomers selected from monomers known to those skilled in the art) to provide the glass transition temperature and the weight average molecular weight within the above ranges.

In one or more embodiments, the monomer mixture may include a (meth)acrylic monomer having a hydroxyl group.

The (meth)acrylic monomer having a hydroxyl group may include at least one selected from among a (meth)acrylic monomer containing a C₁ to C₂₀ alkyl group having a hydroxyl group, a (meth)acrylic monomer containing a C₃ to C₂₀ cycloalkyl group having a hydroxyl group, and a (meth)acrylic monomer containing a C₆ to C₂₀ aromatic group having a hydroxyl group. For example, the (meth)acrylic monomer having a hydroxyl group may include at least one selected from among 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate, as the (meth)acrylic 1 monomer containing a C₁ to C₂₀ alkyl group having a hydroxyl group. These monomers may be used alone or as a mixture thereof.

The (meth)acrylic monomer having a hydroxyl group may be present in an amount of 2 wt % to 5 wt %, for example, greater than 2 wt % and less than or equal to 5 wt %, in the monomer mixture. Within these ranges, the adhesive protective film can (e.g., easily) realize the effects thereof.

In addition to the (meth)acrylic monomer having a hydroxyl group, the monomer mixture may further include a (meth)acrylic monomer having an alkyl group.

The (meth)acrylic monomer having an alkyl group may be a (meth)acrylic acid ester having a straight or branched C₁ to C₂₀ alkyl group in an ester site thereof. For example, the (meth)acrylic acid ester may include at least one selected from among butyl (meth)acrylate (for example, n-butyl (meth)acrylate), pentyl (meth)acrylate (for example, n-pentyl (meth)acrylate), hexyl (meth)acrylate (for example, n-hexyl (meth)acrylate), heptyl (meth)acrylate (for example, n-heptyl (meth)acrylate), octyl (meth)acrylate (for example, n-octyl (meth)acrylate), 2-ethylhexyl (meth)acrylate, nonyl (meth)acrylate (for example, n-nonyl (meth)acrylate), and decyl (meth)acrylate (for example, n-decyl (meth)acrylate).

The (meth)acrylic monomer having an alkyl group may be present in an amount of 40 wt % to 60 wt % in the monomer mixture. Within this range, the (meth)acrylic monomer having an alkyl group can secure peel strength and suitable modulus of the adhesive film.

In addition to the (meth)acrylic monomers having a hydroxyl group and the (meth)acrylic monomers having an alkyl group, the monomer mixture may further include a comonomer copolymerizable therewith.

In one or more embodiments, the (meth)acrylic oligomer may be prepared through polymerization of the monomer mixture by a suitable (e.g., typical) polymerization method. The polymerization method may include any suitable method (e.g., typical method known to those skilled in the art). For example, the (meth)acrylic oligomer may be prepared by adding an initiator to the monomer mixture, followed by suitable (e.g., typical) copolymerization, for example, suspension polymerization, emulsion polymerization, solution polymerization, and/or the like. Polymerization may be performed at a temperature of 65° C. to 70° C. for 6 hours to 8 hours. The initiator may be selected from suitable (e.g., typical) initiators including an azo-based polymerization initiator and/or peroxides, such as benzoyl peroxide or acetyl peroxide.

The (meth)acrylic oligomer may be present in an amount of 0.1 parts by weight to 3 parts by weight, for example, 0.5 parts by weight to 2 parts by weight, or, 0.5 parts by weight to 1 part by weight, relative to 100 parts by weight of the (meth)acrylic copolymer. Within these ranges, the adhesive film can (e.g., easily) realize the effects thereof.

### Aromatic Group-Containing Mono- or Higher Functional (Meth)Acrylic Monomer

The aromatic group-containing mono- or higher functional (meth)acrylic monomer has at least one functional group capable of reacting with an aromatic group by an initiator. Here, the aromatic group may refer to a C₆ to C₅₀ monocyclic or polycyclic functional group. For example, the aromatic group may refer to a substituted or unsubstituted benzyl group, phenyl group, biphenyl group, terphenyl group, or naphthalenyl group, and/or the like. Furthermore, the “functional group” may refer to a vinyl group or a (meth)acrylate group.

The aromatic group-containing mono- or higher functional (meth)acrylic monomer can contribute to improvement in adhesion of the adhesive protective film to an adherend, for example, a plastic film having an aromatic group, for example, a polyimide film, by increasing attractive force of an adhesive layer of the adhesive protective film to the adherend through a stacking effect via a π-π bond to the adherend.

The aromatic group-containing mono- or higher functional (meth)acrylic monomer can increase cohesion and/or modulus of the adhesive protective film.

It is desirable that the homopolymer glass transition temperature of the aromatic group-containing mono- or higher functional (meth)acrylic monomer be in a set or predetermined range relative to the glass transition temperature of the (meth)acrylic copolymer. This condition increases peel strength of the adhesive protective film by suppressing shrinkage of the adhesive protective film even if (e.g., when) the adhesive protective film is cured.

The homopolymer glass transition temperature of the aromatic group-containing mono- or higher functional (meth)acrylic monomer is higher than the glass transition temperature of the (meth)acrylic copolymer and a difference therebetween may be 20° C. or more, for example, 20° C. to 120° C., or 40° C. to 100° C. Within these ranges, the adhesive protective film can secure good wettability with respect to a polyimide-based optical device.

The aromatic group-containing mono- or higher functional (meth)acrylic monomer may have a homopolymer glass transition temperature of −30° C. or more, for example, −30° C. to 50° C. Within these ranges, the aromatic group-containing mono- or higher functional (meth)acrylic monomer has a higher glass transition temperature than the (meth)acrylic copolymer, thereby improving peel strength of the adhesive protective film through improvement in cohesion.

The aromatic group-containing mono- or higher functional (meth)acrylic monomer may include a compound represented by Formula 1, without being limited thereto:

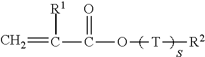

where R¹ is hydrogen or a methyl group;
s is an integer selected from among 0 to 10;
R² is a substituted or unsubstituted C₆ to C₅₀ aryl group or a substituted or unsubstituted C₆ to C₅₀ aryloxy group; and

T is a substituted or unsubstituted C₁ to C₆ alkylene group or a substituted or unsubstituted C₁ to C₆ alkyleneoxy group.

As used herein, the term “substituted” in the expression “substituted or unsubstituted” means that at least one hydrogen atom of a corresponding functional group is substituted with a C₁ to C₁₀ alkyl group, a C₁ to C₁₀ thioalkyl group, a C₁ to C₁₀ alkoxy group, a halogen (F, Cl, Br, or I), a C₃ to C₁₀ cycloalkyl group, or a C₆ to C₂₀ aryl group.

For example, R² may be a substituted or unsubstituted phenoxy group, benzyl group, phenyl group, biphenyl group, terphenyl group, naphthyl group, or the like. For example, the aromatic group-containing mono- or higher functional monomer may include at least one selected from among (e.g., selected from the group consisting of) phenoxy (meth)acrylate, phenoxy benzyl (meth)acrylate, phenoxy polyethylene glycol (meth)acrylate, 2-ethyl phenoxy (meth)acrylate, benzyl (meth)acrylate, phenyl (meth)acrylate, 2-ethyl thiophenyl (meth)acrylate, 2-phenylethyl (meth)acrylate, 3-phenylpropyl (meth)acrylate, 4-phenylbutyl (meth)acrylate, 2-(2-methylphenyl)ethyl (meth)acrylate, 2-(3-methylphenyl)ethyl (meth)acrylate, 2-(4-methylphenyl)ethyl (meth)acrylate, 2-(4-propylphenyl)ethyl (meth)acrylate, 2-(4-(1-methylethyl)phenyl)ethyl (meth)acrylate, 2-(4-methoxyphenyl)ethyl (meth)acrylate, 2-(4-cyclohexylphenyl)ethyl (meth)acrylate, 2-(2-chlorophenyl)ethyl (meth)acrylate, 2-(3-chlorophenyl)ethyl (meth)acrylate, 2-(4-chlorophenyl)ethyl (meth)acrylate, 2-(4-bromophenyl)ethyl (meth)acrylate, 2-(3-phenylphenyl)ethyl (meth)acrylate, o-biphenyl (meth)acrylate, m-biphenyl (meth)acrylate, p-biphenyl (meth)acrylate, 2,6-terphenyl (meth)acrylate, o-terphenyl (meth)acrylate, m-terphenyl (meth)acrylate, p-terphenyl (meth)acrylate, 4-(4-methylphenyl)phenyl (meth)acrylate, 4-(2-methylphenyl)phenyl (meth)acrylate, 2-(4-methylphenyl)phenyl (meth)acrylate, 2-(2-methylphenyl)phenyl (meth)acrylate, 4-(4-ethylphenyl)phenyl (meth)acrylate, 4-(2-ethylphenyl)phenyl (meth)acrylate, 2-(4-ethylphenyl)phenyl (meth)acrylate, 2-(2-ethylphenyl)phenyl (meth)acrylate, and mixtures thereof.

For example, the aromatic group-containing mono- or higher functional (meth)acrylic monomer includes at least one of phenoxy benzyl (meth)acrylate or phenoxy polyethylene glycol (meth)acrylate.

The aromatic group-containing mono- or higher functional (meth)acrylic monomer may be present in an amount of greater than 0 parts by weight and less than or equal to 10 parts by weight, for example, 0.1 parts by weight to 10 parts by weight, 1 part by weight to 5 parts by weight, or, 1 part by weight to 3 parts by weight, relative to 100 parts by weight of the (meth)acrylic copolymer. Within these ranges, the aromatic group-containing mono- or higher functional (meth)acrylic monomer can contribute to increase in peel strength of the adhesive protective film while suppressing shrinkage of the adhesive protective film.

### Heat Curing Agent

The heat curing agent can cure the (meth)acrylic copolymer and (meth)acrylic oligomer to facilitate formation of the matrix of the adhesive film while increasing peel strength of the adhesive film.

The heat curing agent may include at least one selected from among an isocyanate curing agent, a metal chelate curing agent, an epoxy curing agent, an amine curing agent, and an aziridine curing agent.

The isocyanate curing agent may include a bi- to hexa-functional isocyanate curing agent. For example, the isocyanate curing agent may include at least one aromatic isocyanate curing agent selected from among toluene diisocyanate, xylylene diisocyanate, halogen-substituted toluene diisocyanate, phenylene diisocyanate including m-phenylene diisocyanate, and tetramethyl-xylylene diisocyanate, at least one aliphatic isocyanate curing agent selected from among hexamethylene diisocyanate and pentamethylene diisocyanate, and/or at least one alicyclic isocyanate curing agent, for example, cyclohexamethylene diisocyanate and/or the like, or at least one adduct thereof, for example, polyols, for example, trimethylolpropane (TMP), and/or adducts of the curing agents described above.

The metal chelate curing agent is a crosslinking agent including (e.g., consisting of) a metal and a chelate bond and may include any suitable metal chelate crosslinking agent (e.g., typical metal chelate crosslinking agent known to those skilled in the art). In one or more embodiments, the metal chelate crosslinking agent may include a crosslinking agent having at least two, for example, three to six, chelate bonds with a metal. For example, the metal may include aluminum, zirconium, titanium, and/or cobalt. For example, the metal may include aluminum. For example, the chelate may include acetylacetonate, ethylacetoacetate, and/or the like, without being limited thereto. For example, the metal chelate crosslinking agent may include at least one selected from among acetylacetonate aluminate, aluminum tris(acetylacetonate), aluminum tris(ethylacetoacetate), aluminum bis(acetoacetate), zirconium tris(acetylacetonate), and cobalt tris(acetylacetonate), without being limited thereto.

The heat curing agent may be present in an amount of 0.01 part by weight to 1 part by weight, for example, 0.01 part by weight to 0.5 parts by weight, 0.01 part by weight to 0.3 parts by weight, or, 0.2 part by weight to 0.3 parts by weight, relative to 100 parts by weight of the (meth)acrylic binder. Within these ranges, the heat curing agent can secure improvement in peel strength, shear strain, and storage modulus of the adhesive film.

The adhesive composition may further include a curing accelerator.

The curing accelerator can assist in curing reaction of the adhesive protective film to further improve cohesion of an adhesive layer. The curing accelerator may include suitable curing accelerators (e.g., typical curing accelerators known to those skilled in the art). The curing accelerator may include a tin-based metal compound, a zinc-based metal compound, an amine-based compound, a titanium-based metal compound, a bismuth-based metal compound, and an aluminum-based metal compound. In one or more embodiments, tin-based metal compounds are used. For example, the tin-based metal compounds may include tetra- or bivalent organotin-based compounds, such as dibutyltin dilaurate, bis-acetylacetonate-dibutyltin, dibutyltin dimaleate, dibutyltin dimaleate, and/or the like.

The curing accelerator may be present in an amount of 0.001 parts by weight to 3 parts by weight relative to 100 parts by weight of the (meth)acrylic copolymer. Within this range, the curing accelerator can help acceleration of curing of the adhesive protective film while improving cohesion of the adhesive film.

The adhesive composition may further include a silane coupling agent.

The silane coupling agent can further increase peel strength of the adhesive protective film. The silane coupling agent may include suitable silane coupling agents (e.g., typical silane coupling agents known to those skilled in the art). For example, the silane coupling agent may include epoxy group-containing silane coupling agents, such as glycidoxypropyltrimethoxysilane, glycidoxypropylmethyldimethoxysilane, and/or the like, without being limited thereto.

The silane coupling agent may be present in an amount of 0.01 parts by weight to 5 parts by weight relative to 100 parts by weight of the (meth)acrylic copolymer. Within this range, the silane coupling agent can further increase peel strength of the adhesive protective film.

The adhesive composition may further include additives. The additives may include suitable additives (e.g., typical additives for adhesive protective films known to those skilled in the art). For example, the additives may include at least one selected from among pigments, UV absorbents, antioxidants, leveling agents, antistatic agents, retardation agents, catalysts, and reworking agents, without being limited thereto.

The adhesive composition may further include a solvent. The solvent serves to increase coatability of the adhesive composition to form an adhesive protective film having a thin thickness and a uniform surface. The solvent may include suitable solvents (e.g., typical types of solvents known to those skilled in the art). For example, the solvent may include methyl ethyl ketone, methyl isobutyl ketone, ethyl acetate, toluene, and/or the like, without being limited thereto. In one or more embodiments, the adhesive composition may have a solid content of 15 wt % to 40 wt %, for example, 20 wt % to 30 wt %, in terms of solid content of the adhesive protective film. Within these ranges, the composition can have good coatability.

The adhesive protective film may have a haze of 5% or less, for example, 0.1% to 2%, and a total transmittance of 80% or more, for example, 85% to 95%, in the visible spectrum (for example, at a wavelength of 380 nm to 780 nm). Within these ranges, the adhesive protective film can have good optical transparency and can be used in an optical display apparatus.

The adhesive protective film may have an adhesive layer thickness of 200 μm or less, for example, greater than 0 μm to less than or equal to 100 μm, or, 5 μm to 50 μm. Within these ranges, the adhesive protective film can assist in providing a protective effect for a flexible panel.

The adhesive protective film may further include a base film on one surface (e.g., a first surface) thereof.

The adhesive protective film may further include a release film on the other surface (e.g., a second surface opposing the first surface) thereof.

Another aspect of the present disclosure relates to an optical member.

The optical member includes a polyimide-based optical device containing polyimide ash on at least one surface thereof and an adhesive layer bonded to the polyimide ash-containing surface, in which the adhesive layer includes a photo-cured product of the adhesive protective film.

In one or more embodiments, the polyimide-based optical device may be a flexible substrate. The flexible substrate may serve to support an optical device, such as an organic light emitting diode and/or the like.

A suitable (e.g., typical) optical device may be further stacked on at least one surface of the polyimide-based optical device. Such an optical device can provide conductivity and/or optical functions, for example, light emission, polarization, optical compensation, and/or display quality improvement, to an optical display apparatus. For example, the optical device may include an OLED device, a window film, a window, a polarizing plate, a color filter, a retardation film, an elliptical polarizing film, a reflective polarizing film, an antireflection film, a compensation film, a brightness enhancement film, an alignment film, a light diffusion film, a glass-shatterproof film, a surface protection film, an OLED device barrier layer, a plastic LCD substrate, a transparent electrode film including indium tin oxide (ITO), fluorinated tin oxide (FTO), aluminum-doped zinc oxide (AZO), carbon nanotubes (CNT), Ag nanowires, or graphene, and/or the like.

The adhesive layer includes a photo-cured product of the adhesive protective film. The adhesive protective film is substantially the same as the adhesive protective film described above.

In one or more embodiments, the adhesive layer may be patterned.

A protective layer may be further stacked on at least one surface of the adhesive layer.

The protective layer may protect the adhesive layer or the polyimide-based optical device. The protective layer is not limited to a particular kind so long as the protective layer is optically transparent and is capable of providing flexibility. For example, the protective layer may include a polyester film including a polyethylene terephthalate film, a polyethylene naphthalate film, a polycarbonate film, a polyether sulfone film, and/or the like.

FIG. 4 is a cross-sectional view of an optical member according to one or more embodiments. Referring to FIG. 4, the optical member may include a polyimide-based optical device 15 containing polyimide ash on a lower surface thereof, an optical device 20 formed on an upper surface of the polyimide-based optical device 15, and an adhesive layer 33 formed on a lower surface of the polyimide-based optical device 15.

A further aspect of the present disclosure relates to an optical display apparatus.

The optical display apparatus includes a cured product of the adhesive protective film or the optical member. The cured product may be a photo-cured product.

The optical display apparatus may include an organic light emitting diode display, a liquid crystal display, and/or the like. The optical display apparatus may include a flexible display device. However, the optical display apparatus may also include a non-flexible display apparatus.

Next, the present disclosure will be described in more detail with reference to examples. However, it should be understood that these examples are provided for the purpose of illustration only and should not be construed in any way as limiting the disclosure.

### Example 1

A solvent (ethyl acetate) was added to a 1 L reactor configured to allow reflux with nitrogen gas and provided with a cooling device to facilitate temperature control. 100 parts by weight of a monomer mixture including 55 wt % of 2-ethylhexyl acrylate (2-EHA), 40 wt % of n-butyl acrylate (n-BA) and 4 wt % of 4-hydroxybutyl acrylate (4-HBA) were added to the reactor. Nitrogen gas was introduced into the monomer mixture for 30 min to remove oxygen and the temperature of the reactor was maintained at 62° C. While uniformly stirring the monomer mixture, 0.07 wt % of an initiator (azobisisobutyronitrile) was added to the monomer mixture and reacted at 62° C. for 8 hours to prepare a (meth)acrylic copolymer (glass transition temperature: −60° C., weight average molecular weight: 600,000 g/mol). A (meth)acrylic copolymer solution (solid content: 24 wt %) was prepared by adding ethyl acetate as a solvent to the resulting product.

### Preparation of Adhesive Protective Film

An adhesive composition for adhesive films (solid content: 25 wt %) was prepared by mixing 100 parts by weight of the prepared (meth)acrylic copolymer, 1 part by weight of a (meth)acrylic oligomer (prepared from a monomer mixture including 5 wt % of a hydroxyl-containing (meth)acrylic monomer, having a weight average molecular weight of 30,000 g/mol and a glass transition temperature of 30° C.), 0.23 parts by weight of an isocyanate curing agent (Coronate-L, TOSOH), and 1 part by weight of phenoxybenzyl acrylate (PBA) in terms of solid content.

The prepared adhesive composition was deposited to a thickness of 25 μm on an antistatic layer-coated surface of a base film (polyethylene terephthalate (PET) film, T914J75, thickness: 50 μm, with an antistatic layer coated on one surface, MCC) and was dried at 110° C. for 4 min to form an adhesive layer. Then, a release film (thickness: 50 μm, with one surface subjected to silicone release treatment, MHF50, MCC) was bonded to the adhesive layer and left at 60° C. for 3 days, thereby preparing an adhesive protective film-containing sheet in which the adhesive protective film (thickness: 25 μm) and the release film are sequentially stacked on the base film.

### Examples 2 to 4

Adhesive protective film-containing sheets were prepared in the same manner as in Example 1 except that the kind and/or content of each component in Example 1 was changed as shown in Table 1.

### Comparative Examples 1 to 5

Adhesive protective film-containing sheets were prepared in the same manner as in Example 1 except that the kind and/or content of each component in Example 1 was changed as shown in Table 1.

The adhesive protective film-containing sheets prepared in Examples and Comparative Examples were evaluated as to the following properties and evaluation results are shown in Table 1.

### Reference Example: Preparation of Polyimide Layer Containing Polyimide Ash on One Surface

A polyimide layer containing polyimide ash on one surface was prepared.

A polyimide varnish (SD Flex, DuPont) was deposited to a thickness of 20 μm on an upper surface of an alkali-free glass plate (thickness: 1.1 mm) using a doctor blade coating device (gauge diameter: 0.65 mm) to prepare a polyimide varnish coat.

The polyimide varnish coat was subjected to heat treatment at 80° C. for 10 min and at 120° C. for 20 min to prepare a dry film (thickness: 20 μm) of the polyimide varnish coat.

A laminate of the polyimide layer (thickness: 20 μm) and the glass plate was prepared by curing the dried polyimide varnish layer in a chamber at 250° C. for 60 min.

The laminate was irradiated with laser beams while moving a laser irradiation device (MicroLAS, COHERENT) placed above the glass plate of the laminate from one side to the other side. Laser irradiation was performed under conditions of wavelength: 308 nm, femtosecond, dose: 170 mJ/cm².

After holding the laminate at room temperature for 1 hour, a polyimide layer containing polyimide ash on one surface thereof was prepared by removing the glass plate.

### (1) Storage Modulus (Unit: MPa):

The adhesive protective films prepared in each of Examples and Comparative Examples were stacked to a thickness of 800 μm and storage modulus was measured at −20° C. under conditions of an axial force of 1.0 N, a sensitivity of 0.1 N, and a frequency of 1.0 Hz using DHR3.

### (2) Creep (Unit: %)

The adhesive protective films manufactured in the Example and Comparative Examples were stacked to a thickness of 800 μm and creep was measured at 60° C. under conditions of an axial force of 1.0 N, a sensitivity of 0.1 N, and a frequency of 1.0 Hz using DHR3.

### (3) Peel Strength (Unit: Gf/Inch) Under High Temperature/Humidity Conditions

Only the release film was peeled off of each of the adhesive protective film-containing sheets of Examples and Comparative Examples to expose the adhesive protective film. The exposed surface of the adhesive protective film was attached to the polyimide ash-containing surface of the polyimide layer. Then, a specimen was prepared by pressing the resulting product under a 1 kg load roll and cutting the pressed product to a size of 25 mm×100 mm (width×length). The specimen was a laminate of the PET film, the adhesive protective film and the polyimide layer containing polyimide ash.

The specimen was left at 23° C. and 50% RH (relative humidity) for 30 min. Peel strength of the adhesive protective film was measured when the adhesive protective film was peeled off of the polyimide ash-containing surface using a peel strength tester (Instron Inc.) by a peel strength measurement method at 23° C. and 50% RH under conditions of peeling temperature: 60° C., peeling speed: 300 mm/min, and peeling angle: 180° in accordance with JISZ2037.

### (4) Simulated Bubble Fraction (Unit: %)

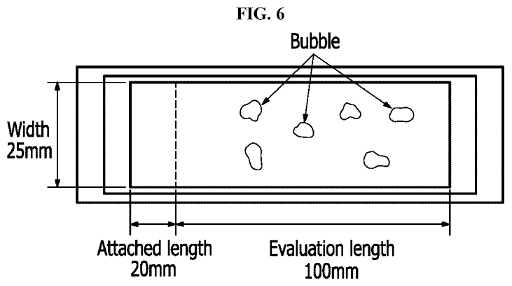

Simulated bubble fraction was evaluated with reference to FIG. 5 and FIG. 6. An adhesive protective film-containing sheet was cut into a rectangular shape having a predetermined length and width. Then, a polyimide (PI) film was placed on a glass plate, a release film was peeled off of the adhesive protective film-containing sheet, and the exposed adhesive side in turn was partially attached to the polyimide film to prepare a specimen, as shown in FIG. 5.

Then, with the laminate of the adhesive protective film and the base film placed on the polyimide film side, a ratio of a bubble area to the total area of the polyimide film was calculated. The bubble area was evaluated using an image analyzer.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| Copolymer | 2-EHA | 55 | 55 | 55 | 55 | 55 | 55 | 55 | 55 | 55 |
| | n-BA | 40 | 40 | 40 | 40 | 40 | 40 | 40 | 40 | 40 |
| | 4-HBA | 5 | 5 | 5 | 5 | 5 | 5 | 5 | 5 | 5 |
| | Content | 100 | 100 | 100 | 100 | 100 | 100 | 100 | 100 | 100 |
| Curing agent | | 0.23 | 0.23 | 0.23 | 0.23 | 0.26 | 0.13 | 0.26 | 0.23 | 0.23 |
| Oligomer | | 1 | 1 | 1 | 1 | 1 | 1 | 1 | 1 | — |
| Aromatic | PBA | 1 | 2 | 3 | — | 4 | 3 | — | — | 1 |
| group | PHEA-2 | — | — | — | 3 | — | — | 4 | — | — |
| monomer | ACMO | — | — | — | — | — | — | — | 1 | — |

| | | | | | | | | | |
|---|---|---|---|---|---|---|---|---|---|
| Storage modulus | 0.07 | 0.08 | 0.09 | 0.09 | 0.11 | 0.09 | 0.11 | 0.08 | 0.07 |
| Creep | 26 | 33 | 40 | 40 | 38 | 50 | 38 | 35 | 25 |
| Peel strength | 377 | 450 | 536 | 467 | 545 | 570 | 483 | 350 | 320 |
| Simulated bubble fraction | 3.50 | 3.10 | 2.50 | 2.50 | 2.10 | 4.10 | 2.20 | 3.80 | 3.40 |

In Table 1,

PBA: Phenoxybenzyl acrylate (homopolymer Tg: 6° C.) represented by Formula:

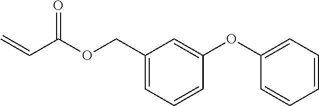 [SMILES: C=CC(=O)OCc1cccc(Oc2ccccc2)c1]

PHEA-2: Phenoxy polyethylene glycol acrylate (homopolymer Tg: −13° C.) represented by Formula:

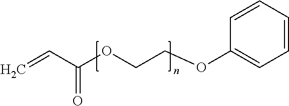

ACMO: Acryloylmorpholine (no aromatic group, homopolymer Tg: 145° C.).

As shown in Table 1, the adhesive protective films according to the present disclosure exhibited high adhesive strength with respect to a polyimide-based optical device containing polyimide ash under high temperature/humidity conditions, good foldability, and good wettability with respect to the polyimide-based optical device containing polyimide ash.

Embodiments of the present disclosure provides an adhesive protective film that includes a heat cured product of a composition including a (meth)acrylic copolymer, a curing agent, a (meth)acrylic oligomer, and an aromatic group-containing mono- or higher functional (meth)acrylic monomer. The adhesive protective film has a storage modulus of 0.1 MPa or less at −20° C., a peel strength of 350 gf/inch or more at 60° C. and 93% relative humidity with respect to a polyimide-based optical device containing a polyimide ash, and a creep of 40% or less at 60° C.

Embodiments of the present disclosure provides an optical member that includes a polyimide-based optical device having at least one surface containing a polyimide ash thereon and the adhesive layer protective film bonded to the at least one surface.

Embodiments of the present disclosure provides an optical member that includes a polyimide-based optical device having at least one surface containing a polyimide ash thereon and an adhesive layer bonded to the at least one surface. The adhesive layer is a photo-cured product of the adhesive protective film.

Embodiments of the present disclosure provides an optical display apparatus that includes a cured product of the adhesive protective film or include the optical member.

Embodiments of the present disclosure provides a method of manufacturing an optical member. The method includes forming a polyimide layer on a substrate; irradiating a surface of the polyimide layer through the substrate to generate polyimide ash on a surface of the polyimide layer; removing the substrate from polyimide layer; forming an adhesive protective film; and attaching the adhesive protective film on the surface of the polyimide layer.

The method may further include photo-curing the adhesive protective film.

In the context of the present application and unless otherwise defined, the terms “use,” “using,” and “used” may be considered synonymous with the terms “utilize,” “utilizing,” and “utilized,” respectively.

The use of “may” when describing embodiments of the inventive concept refers to “one or more embodiments of the inventive concept.”

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. It should be understood that various modifications, changes, alterations, and equivalent embodiments can be made by those skilled in the art without departing from the spirit and scope of the disclosure.

What is claimed is:

1. An adhesive protective film comprising a cured product of a composition comprising:
a (meth)acrylic copolymer;
a curing agent;
a (meth)acrylic oligomer; and
an aromatic group-containing mono- or higher functional (meth)acrylic monomer,
wherein the adhesive protective film has a storage modulus of 0.1 MPa or less at −20° C., a peel strength of 350 gf/inch or more at 60° C. and 93% relative humidity with respect to a polyimide-based optical device comprising a polyimide ash, and a creep of 40% or less at 60° C., and
wherein the adhesive protective film is for polyimide-based optical devices comprising polyimide ash.

2. The adhesive protective film as claimed in claim 1, wherein the (meth)acrylic copolymer has a glass transition temperature (Tg) of −10° C. or less.

3. The adhesive protective film as claimed in claim 1, wherein the (meth)acrylic copolymer is a copolymer of a monomer mixture comprising a (meth)acrylic monomer having a homopolymer glass transition temperature of 60° C. or less and a (meth)acrylic monomer having a crosslinking functional group.

4. The adhesive protective film as claimed in claim 3, wherein the (meth)acrylic monomer having the homopolymer glass transition temperature of 60° C. or less and the (meth)acrylic monomer having the crosslinking functional group are present in a total amount of 95 wt % or more based on 100 wt % of the monomer mixture.

5. The adhesive protective film as claimed in claim 4, wherein the (meth)acrylic monomer having the crosslinking functional group is present in an amount of 0.1 wt % to 20 wt % based on 100 wt % of the monomer mixture.

6. The adhesive protective film as claimed in claim 4, wherein the (meth)acrylic monomer having the homopolymer glass transition temperature of 60° C. or less is a mixture comprising a (meth)acrylic acid ester having a straight C₁ to C₂₀ alkyl group and a (meth)acrylic acid ester having a branched C₁ to C₂₀ alkyl group.

7. The adhesive protective film as claimed in claim 1, wherein the (meth)acrylic oligomer has a glass transition temperature of 60° C. or less and a weight average molecular weight of 100,000 g/mol or less.

8. The adhesive protective film as claimed in claim 1, wherein the aromatic group-containing mono- or higher functional (meth)acrylic monomer has a homopolymer glass transition temperature of −20° C. or more.

9. The adhesive protective film as claimed in claim 8, wherein the aromatic group-containing mono- or higher functional (meth)acrylic monomer comprises at least one of phenoxybenzyl (meth)acrylate or phenoxy polyethylene glycol (meth)acrylate.

10. The adhesive protective film as claimed in claim 1, wherein the composition comprises: 100 parts by weight of the (meth)acrylic copolymer; 0.01 parts by weight to 1 part by weight of the curing agent; 0.1 parts by weight to 3 parts by weight of the (meth)acrylic oligomer; and greater than 0 parts by weight to less than or equal to 10 parts by weight of the aromatic group-containing mono- or higher functional (meth)acrylic monomer.

11. An optical member comprising:
a polyimide-based optical device having at least one surface comprising a polyimide ash thereon; and
an adhesive layer bonded to the at least one surface,
wherein the adhesive layer comprises a photo-cured product of the adhesive protective film as claimed in claim 1.

12. An optical display apparatus comprising the optical member as claimed in claim 11.

13. A method of manufacturing an optical member, the method comprising:
forming a polyimide layer on a substrate;
generating a polyimide ash by irradiating the polyimide layer through the substrate to form a polyimide ash-containing surface;
removing the substrate from polyimide layer;
forming an adhesive protective film; and
attaching the adhesive protective film on the polyimide ash-containing surface,
wherein the adhesive protective film comprising a cured product of a composition comprising:
a (meth)acrylic copolymer;
a curing agent;
a (meth)acrylic oligomer; and
an aromatic group-containing mono- or higher functional (meth)acrylic monomer,
wherein the adhesive protective film has a storage modulus of 0.1 MPa or less at −20° C., a peel strength of 350 gf/inch or more at 60° C. and 93% relative humidity with respect to polyimide ash-containing surface, and a creep of 40% or less at 60° C.

14. The method as claimed in claim 13, further comprising photo-curing the adhesive protective film to form an adhesive layer.
